(19) United States
(12) Patent Application Publication
(10) Pub. No.: US 2004/0136779 A1
(43) Pub. Date: Jul. 15, 2004

(54) Connector

(76) Inventor: Vishal Bhaskar, Troy, MI (US)

Correspondence Address: STEPHEN D. SCANLON, JONES DAY, 901 LAKESIDE AVENUE, CLEVELAND, OH, 44114, US

(21) Appl. No.: 10/341,104

(22) Filed: Jan. 13, 2003

(51) Int. Cl. B25G 3/00

(52) U.S. Cl. 403/353

(57) ABSTRACT

A two-part connector includes a male member and a female member. The male member is inserted transversely into an opening in the female member such that the male and female member are axially aligned. Once inserted, the male member is locked in the female member and rotatable relative to the female member. A method for coupling an automotive cable assembly is also provided.

### FIELD OF THE INVENTION

The claimed invention relates to a connector. In particular, the invention concerns a coaxial connector for locking two cables to one another.

### BACKGROUND OF THE INVENTION

Cable assemblies are utilized in vehicles, inter alia, to connect a transmission control arm to a vehicle shift lever. The connection of the cable assembly is such that movement of the vehicle shift lever is transmitted through a transmission shift cable or cable strand and results in actuation or movement of the transmission control arm.

Installation of a transmission shift cable during vehicle assembly can be a time-consuming procedure. Cable assemblies typically include two cables that are joined to one another during the final assembly of the vehicle. One cable is initially connected to the transmission and the other cable is initially attached to the vehicle shift lever. Since the power train and chassis of the vehicle are usually assembled separately from the vehicle body and interior, one cable is attached to the chassis and drive chain while the other cable is attached to the body and interior. The cables are left hanging during vehicle assembly. When the power train and chassis are joined with the body and interior during final assembly, the cables are joined utilizing a connector.

Conventional connectors for cable assemblies use three or more parts to connect the ends of the cables. For example, one connector uses a male part, a female part, and a clip to lock the male and female parts together.

### SUMMARY

According to the claimed invention, a connector comprises a male member and a female member. The male member has a head portion at a first end and a shaft portion at a second end. The shaft portion is connected to the head portion. The female member has a first end and a second end, with an open groove extending through the female member between the first and second ends. The open groove is configured to receive the head portion of the male member. The female member also includes an open channel coupled to the open groove extending through the female member. The open channel is configured to catch the shaft portion of the male member. The open channel is open at the second end for receiving the shaft portion of the male member. The male member is configured relative to the female member to allow rotation of the male member when positioned inside the female member.

In another embodiment, a connector for an automotive cable assembly comprises a female member and a male member. The female member has an opening extending transversely through its side and the male member is configured to seat in the side opening of the female member. The male member is inserted transversely into the side opening of the female member to securely couple the male and female members in axial alignment.

In yet another embodiment, a cable connector comprises a female member and a male member. The female member has a first cable connecting end and a second open end. The second open end comprises a body portion having a longitudinal channel that extends at least partially along the length of the body portion. The male member is configured to securedly seat inside the second open end of the female member and comprises a head portion at one end and a shaft portion at a second end. The second end of the male member is a cable connecting end. The longitudinal channel of the female member includes a groove sized to receive the head portion of the male member and the longitudinal channel is configured to catch the shaft portion of the male member.

In a further embodiment, a two part connector for an automotive cable assembly includes a first part and a second part. The second part is configured to couple to and is coupled to the first part. When the second part is coupled to the first part, the first and second parts are locked together.

The invention also relates to a method of coupling an automotive cable assembly. The method comprises providing a male member and a female member, as discussed above, positioning the head portion of the male member into the open groove of the female member, and positioning the shaft of the head portion into the open channel of the female member such that the male member is in axial alignment with the female member.

In yet another embodiment, a method of coupling an automotive cable assembly comprises providing the male and female members, as discussed above, and transversely inserting the male member into the side opening of the female member.

In a further embodiment, a method of coupling an automotive cable assembly comprises providing the first and second parts, as discussed above, and inserting the second part into the first part until the first and second parts lock together.

### BRIEF DESCRIPTION OF THE DRAWING FIGURES

FIG. 1 is a perspective view of one embodiment of the male and female members of the cable assembly according to the invention, with the male and female members being coupled together;

FIG. 2 is an exploded view of the male and female members of the connector shown in FIG. 1 prior to assembly of the connector;

FIG. 3 is a cross-sectional view of the male member of the connector taken along line 3-3 in FIG. 2;

FIG. 4 is a top view of the female member of the connector;

FIG. 5 is a partial cross-sectional view of the female member of the connector taken at line 5-5 in FIG. 4; and

FIG. 6 is a right end view of the female member shown in FIG. 4.

### DETAILED DESCRIPTION OF THE INVENTION

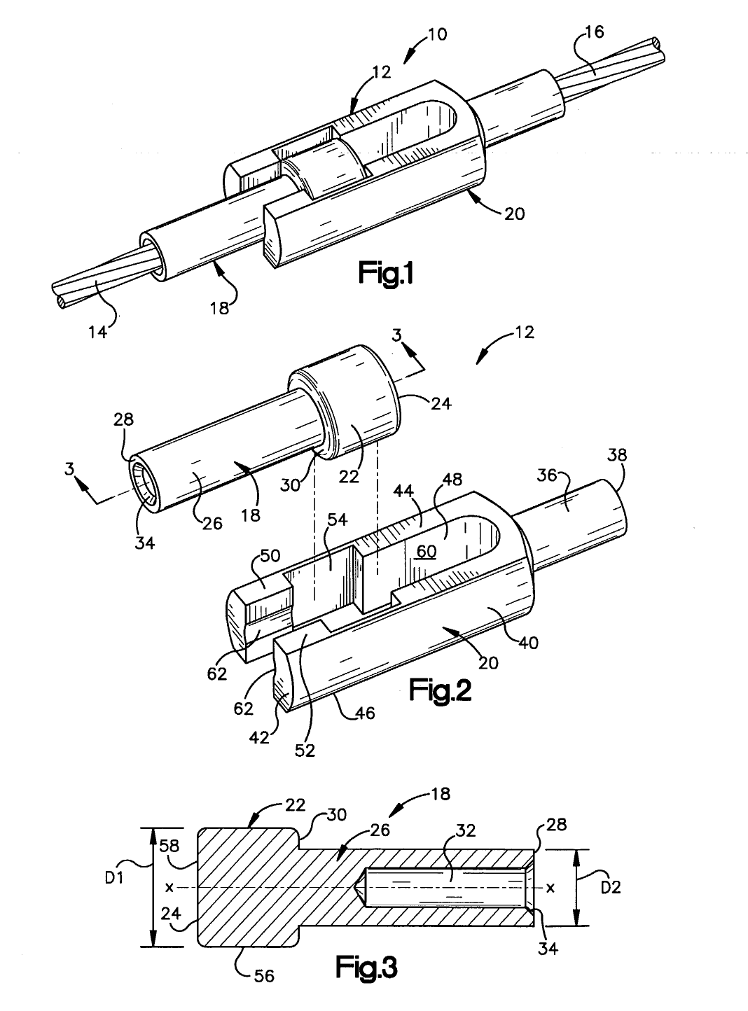

FIG. 1 shows part of a cable assembly 10 for use in a vehicle transmission. FIG. 2 shows the connector 12 of the cable assembly 10 of FIG. 1, but in an unassembled position. The connector 12 includes a male member 18 coupled to a female member 20. The male member 18 has a longitudinal axis X-X and the female member 20 has a longitudinal axis Y-Y. The cable assembly 10 includes the connector 12, a first cable 14 extending axially from the male member 18, and a second cable 16 extending axially from the female member 20. The connector 12 of the cable assembly 10 is primarily intended for use in a vehicle transmission, as described herein. However, other uses that are unrelated to a vehicle transmission are also contemplated, the invention not being limited to a cable assembly 10 or a connector 12 for use in a vehicle. The connector 12 is designed to join two cables 14, 16 together, but may be employed to join parts other than cables. While the description that follows is limited primarily to usage of the connector in a vehicle transmission, the present invention is not limited to such an application.

In a vehicle, one cable 14 of the cable assembly 10 is typically coupled to the vehicle's transmission while the other cable 16 of the assembly 10 is coupled to the vehicle's shift lever, which is used to control the transmission. By providing the cable assembly 10 as a two part assembly, the respective portions of the vehicle may be shipped independently to various vehicle assembly or build areas, where the various portions of the vehicle can be assembled. During final assembly, when the various portions of the vehicle are joined, the operator need simply connect the male and female members 18, 20 of the present invention to one another to complete the cable assembly 10. The use of the male and female members 18, 20 of the present invention provides flexibility to the operator and greatly reduces the amount of time needed to assemble and connect a shift lever to a transmission. In addition, the connector 12 provides a quick release fitting when installed that remains connected during use.

The connector 12 of the present invention requires only two members to lock the cable assembly 10 together. While the description that follows describes a specific configuration for the connector 12, it should be noted that other two-part configurations may also be utilized, the invention not being limited to the specific shapes or configurations shown in the accompanying figures. The preferred embodiment should utilize a two-part connector 12 that positively locks when the two parts of the connector are installed together. In addition, a preferred embodiment of the two-part connector 12 uses transverse loading of the male member 18 into the female member 20.

As shown in FIG. 2, the two-part connector 12 of the present invention uses a male member 18 that is loaded transversely into the female member 20 to complete the connector 12. Rather than inserting the male member 18 into the female member 20 axially, as is known in the art, the male member 18 is inserted or loaded transversely, so that the male member 18 enters the side of the female member 20, rather than the end. When the male and female members are joined, they are axially aligned such that the longitudinal axis X-X of the male member 18 aligns with the longitudinal axis Y-Y of the female member 20. An additional feature of the invention provides that the male member 18 locks into the female member 20, such that the two parts of the connector 12 will not separate except with the application of a sufficient transverse force that is greater than the transverse forces that may be encountered during normal usage.

The male member 18 includes a head portion 22 at a first end 24 and a shaft portion 26 connected to and extending from the head portion 22 at the second end 28. In the embodiment shown, both the head and shaft portions 22, 26 are cylindrical, with the head portion 26 having a diameter D1 that is greater than the diameter D2 of the shaft portion 26. A shoulder 30 is positioned between the head portion 22 and the shaft portion 26. The outer edges of the head portion 22 may be rounded to reduce or remove any burrs or other unwanted imperfections that may be produced during manufacturing. Other shapes for the head portion 22 and shaft portion 26 may also be utilized according to the claimed invention.

As shown in FIG. 3, a longitudinal bore 32 extends part way through the shaft portion 26 of the male member 18. This longitudinal bore 32 is utilized for coupling the male member 18 to the first cable 14, as shown in FIG. 1. The longitudinal bore 32 is cylindrical and may be manufactured by drilling out the shaft 26 using a conventional drill. The longitudinal bore 32 is preferably centered in the shaft 26 and has a fixed length. By providing a fixed length, the bore 32 serves as a positive stop for the cable 14 such that only a predetermined length of cable may be inserted into the bore 32. The longitudinal bore 32 includes a chamfered inner edge 34 at the second end 28. The chamfered inner edge 34 assists in the insertion of a cable into the bore 32. Once the cable 14 is fully inserted into the bore 32, the shaft 26 is crimped around the cable 14 to retain the cable firmly in position within the bore. The cable 14 is preferably secured within the bore 32 to meet any pulling off requirements in the automotive industry, as known by those of skill in the art.

The female member 20, as shown in FIGS. 2 and 4-6, includes a shaft portion 36 positioned at a first end 38 and a body portion 40 connected to and extending from the shaft portion 36 at the second end 42. The body portion 40 has a first side 44 and a second side 46 and, in a preferred embodiment, is U-shaped. The U-shaped body 40 includes a longitudinal open channel 48 that extends transversely through the body portion 40 along part of the length thereof to define a first leg 50 and a second leg 52 of the body portion 40. An open groove 54 also extends transversely through the U-shaped body portion 40 between the first and second sides 44, 46 and cuts into each of the first and second legs 50, 52. The open groove 54 is positioned along the open channel 48, but provides a greater open width in the body portion 40 than the width of the open channel 48. The open channel 48 and open groove 54 may be formed in separate manufacturing operations by drilling transversely through the side of the body portion 40. Utilizing this manufacturing technique, the open channel 48 and open groove 54 will take on the shape of the drill bit utilized to drill the respective openings. In addition, the open channel 48 may be formed in more than one manufacturing operation, where different dimensions, profiles, or opening shapes are desired. Other manufacturing techniques or processes may also be utilized.

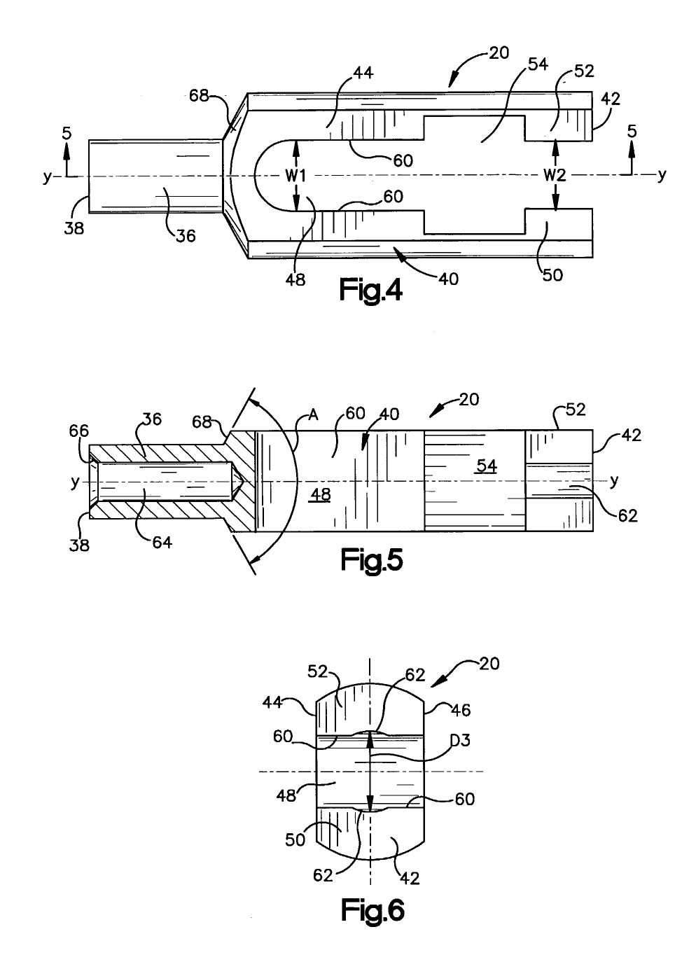

The open groove 54 of the female member 20 is positioned axially between the first and second ends 38, 42 of the female member 20 and is generally rectangular in shape, as shown best in the side view of FIG. 4. The open groove 54 is sized to accept the head portion 22 of the male member 18, such that when the male member 18 is inserted from either the first or second sides 44, 46 of the female member 20 into the open groove 54, the head portion 22 seats in the open groove 54. The open groove 54 is preferably dimensioned such that the head portion 22 of the male member 18 is freely rotatable in the groove 54. In this freely rotatable configuration, fewer stresses are incurred by the parts. In a preferred embodiment, 0.1 to 0.2 mm of clearance is provided between the head portion 22 of the male member 18 and the open groove 54 of the female member 20 on both the side 56 of the head portion 22 and at the top 58 and shoulder 30 of the head portion 22.

The open channel 48 of the female member 20 extends from a point between the first and second ends 38, 42 of the female member 20 to the second end 42 of the female member 20. The open channel 48 is open from the first and second sides 44, 46, and is also open at the second end 42 of the female member 20 such that the first and second legs 50, 52 of the body portion 40 surround the open channel 48 and the opening in the second end 42. As part of the locking feature of the present invention, the open channel 48 has a width that is sized to allow an interference fit with the shaft portion 26 of the male member 18, such that force is needed to push the shaft portion 26 of the male member 18 between the first and second legs 50, 52. Once the shaft portion 26 is positioned between the legs 50, 52, it is rotatably locked in position, as is described in greater detail below. The open channel 48 has a length that is greater than the length needed for insertion of the male member 18 into the female member 20. The length of the open channel 48 provides longer legs 50, 52 on the body portion 40 of the female member 20. By providing longer legs 50, 52, greater flexibility is afforded to the female member 20 in order to allow the entrance of the male member 18 into the open channel 48. Depending on the stiffness of the material utilized for the male and female members 18, 20, the length of the open channel 48 may be modified from the design shown herein.

The open channel 48 may have differing dimensions along its length. For instance, as shown in FIG. 4, the open channel 48 has a width W1 between the open groove 54 and the first end 38, and a width W2 between the open groove 54 and the second end 42. W1 may be equal to W2, less than W2, or greater than W2. In the embodiment shown in FIG. 4, W1 is greater than W2. Differing widths may be utilized based upon the manufacturing process selected and the amount of flex required in legs 50, 52. In particular, it may be more cost effective to specify a dimension at W1 with general tolerances (which are less accurate) and to specify a dimension at W2 with close tolerances (which are more accurate). Since the part of the open channel at W1 is not utilized for the insertion of the male member 18, close tolerances, which are typically more costly to manufacture, can be avoided.

In a preferred embodiment, the first and second legs 50, 52 have flat inner side walls 60, as shown best in FIGS. 2, 4, and 6, although the invention is not limited to an open channel having flat side walls. In addition, the open channel 48 includes a recessed portion 62 positioned on the legs 50, 52 at the second end 42 of the female member 20. As shown in FIGS. 2 and 6, a pair of longitudinal recesses 62 are positioned on the inner side walls 60 of the legs 50, 52. The longitudinal recesses 62 extend from the open groove 54 to the second end 42, and are positioned approximately half the distance between the first and second sides 44, 46 of the female member 20. The longitudinal recesses 62 may be manufactured using a single drill bit that drills a hole along the longitudinal axis X-X of the male member. The longitudinal recesses 62 may be formed either before or after formation of the open channel 48.

As part of the locking feature of the invention, the longitudinal recesses 62, when combined, form a cylindrical shape that has a diameter D3 that is slightly larger than the diameter D2 of the shaft portion 26 of the male member 18, as shown in FIG. 6. In a preferred embodiment, diameter D3 is about 0.1 to 0.2 mm greater than diameter D2 of the shaft portion 26. In use, when the shaft portion 26 is forced between the legs 50, 52 of the female member 18, the shaft portion 26 encounters resistance from the interference fit of the legs 50, 52. Once the shaft portion 26 is inserted far enough between the legs 50, 52, such that the shaft portion 26 reaches the longitudinal recesses 62, the shaft 26 snaps or locks into the recesses 62, since less resistance is encountered at the recesses 62. Thus, once the shaft portion 26 of the male member 18 is inserted into the open channel 48, the shaft portion 26 is guided into and locked in the longitudinal recesses 62. Once the shaft portion 26 is seated between the longitudinal recesses 62 and the head portion 22 is positioned in the open groove 54, the male member 18 is free to rotate within the female member 20 with little, if any, resistance.

The interference fit created between the open channel 48 and the shaft portion 26 of the male member 18 helps to lock and firmly maintain the male member 18 within the female member 20, thus completing the cable assembly 10. In a preferred embodiment, about 0.25 mm of interference is created between the shaft portion 26 and each of the legs 50, 52. The male member 18 may be removed from the female member 20 if a sufficient amount of transverse force is applied to the male member 18 to move the shaft portion 26 past the legs 50, 52 and out of the longitudinal recesses 62. The amount of force necessary to remove the male member 18 from the female member 20 is greater than the force that will be encountered during normal usage. Thus, the male member 18 will be maintained in axial alignment with the female member 20, without the need for a clip or other fastener to secure the male and female members together. In particular, when installed in a vehicle, the cable assembly 10 must be able to withstand 890 Newtons tensile load without yielding and 180 Newtons compressive load with no more than 1.3 mm deflection. Testing to confirm proper operation is performed at a temperature range of 120 degrees C. to −40 degrees C. The tensile load and compressive load requirements may change depending on the particular application.

Referring to FIGS. 2 and 4-6, the shaft portion 36 of the female member 20 includes a longitudinal bore 64. The bore 64 extends along a portion of the length of the shaft portion 36, as shown in FIGS. 5 and 6, and is utilized to couple the female member 20 to the second cable 16, as shown in FIG. 1. The longitudinal bore 64 is cylindrical and may be manufactured by drilling out the bore along the longitudinal axis Y-Y of the female member 20 using conventional drilling equipment. The longitudinal bore 64 is preferably centered in the shaft portion 36 and includes a chamfered inner edge 66 at the first end 38. The chamfered inner edge 66 assists the insertion of a cable 16 into the bore 64. The bore 64 preferably has a length sized to accept a predetermined length of cable 16. The length of the bore 64 serves as a positive stop for the cable 16, and the cable 16 is preferably inserted all the way into the bore 64. Once the cable 16 is inserted into the bore 64, the shaft portion 36 is crimped around the cable 16 to retain the cable 16 firmly in position within the bore 64. The cable 16 is preferably secured within the bore 64 to meet any pulling off requirements in the automotive industry, as known by those of skill in the art.

The shaft portion 36 meets the body portion 40 of the female member 20 along a shoulder 68. The shoulder 68 is preferably conical and beveled toward the body portion 40, as shown in FIGS. 4 and 5. A preferred angle A for the cone shape is about 122 degrees, although other constructions for the shoulder 68 may be utilized, the invention not being limited to a particular bevel angle A for the shoulder. It is preferred that the shoulder 68 be beveled in order to reduce the strain on the female member 20. The use of a beveled surface helps to distribute the longitudinal load between the body portion 40 and the shaft portion 36 around the shoulder 68 and helps to prevent shearing of the female member 20 at the shoulder 68.

The male and female members 18, 20 are preferably formed of steel, although other materials may also be utilized. A preferred material is metallic, is easily machinable, and does not have rough surfaces after finishing. Examples of materials that may be utilized with the invention include mild steel or free machining steel 1213 per SAE J403. Other materials may also be utilized.

In a preferred embodiment, the male member 18 has a length of about 20 mm, the head portion 22 of the male member has a length of about 6 mm and a width of about 7 mm, the shaft portion 26 of the male member 18 has a length of about 14 mm and a width of about 4.5 mm, and the bore 32 of the shaft portion 26 of the male member 18 has a length of about 10 mm and a width of about 2.3 mm. The female member 20 has a length of about 30 mm, the body portion 40 of the female member has a width of about 9.8 mm and a height of about 6 mm, the shaft portion 36 of the female member 20 has a length of about 8.5 mm and a width of about 4.4 mm. The open groove 54 of the female member 20 preferably has a length of about 6 mm and a width of about 7 mm. The open channel 48 of the female member 20 preferably has a length of about 18 mm and a width of about 4 mm, and the open groove 54 is positioned about 4 mm from the second end 42 of the female member 20. The longitudinal recesses 62 in the legs 50, 52 of the body portion 40 of the female member 20 preferably have a combined diameter of 4.5 mm. These dimensions are given for exemplary purposes only, the invention not being limited to these dimensions. Tolerances for the various parts are not included in the description above, but the dimensions of the finished parts would be consistent with clearances discussed in the text preceding the above dimensions.

The invention further includes a method for coupling the female and male members 20, 18 for use in an automotive cable connector 12. The method includes providing the male member 18 and the female member 20, discussed above, and inserting the male member 18 transversely through the side of the female member 20 into the open channel 48 and open groove 54 of the female member 20. The male member 18 is inserted into the female member 20 until the shaft portion 26 of the male member 18 encounters the longitudinal recesses 62 formed in the legs 50, 52 of the body portion 40 of the female member 20 and the head portion 22 of the male member 18 encounters the groove 54 in the female member 20. Once the male member 18 is fully inserted into the female member 20 such that the shaft portion 26 is positioned in the recesses 62 in the legs 50, 52, the male member 18 is locked in position and is rotatable within the female member 20.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A connector comprising:
a male member having a head portion at a first end and a shaft portion at a second end, with the shaft portion being connected to the head portion; and
a female member having a first end and a second end, with an open groove extending therethrough between the first and second ends configured to receive the head portion of the male member, and an open channel coupled to the open groove extending therethrough to catch the shaft portion of the male member, said open channel being open at the second end for receiving the shaft portion of the male member, wherein the male member is configured relative to the female member to allow rotation of the male member when positioned inside the female member.

2. The connector of claim 1, wherein the head portion of the male member is cylindrical and the shaft portion of the male member is cylindrical; and
a longitudinal bore extends along at least a portion of the length of the shaft portion of the male member, said bore being configured for coupling to a cable.

3. The connector of claim 1, wherein the open groove of the female member has a rectangular cross-section and extends transversely through the female member.

4. The connector of claim 1, wherein the open channel of the female member has a U-shaped profile and is sized for rotatably receiving the shaft portion of the male member.

5. The connector of claim 4, wherein the open channel of the female member includes a pair of recesses that extend longitudinally from the open groove to the second end of the female member, said longitudinal recesses for catching the shaft portion of the male member when the male member is positioned in the female member and rotatably locking the male and female members together.

6. The connector of claim 1, wherein the female member includes a shaft at the first end coupled to a body portion at the second end, with the body portion being generally U-shaped and including a first leg and a second leg positioned on either side of the U-shape, said shaft portion being configured for coupling with a cable, with the open groove and open channel extending transversely through the body portion.

7. The connector of claim 6, wherein the shaft portion of the female member includes a longitudinal bore configured to couple to a cable.

8. The connector of claim 1, wherein the head portion has a diameter that is about 0.1 to 0.2 mm smaller than the width of the open groove, and a length that is about 0.1 to 0.2 mm smaller than the length of the open groove.

9. The connector of claim 5, wherein the pair of recesses had an arcuate cross-section and are positioned on a common diameter, and the common diameter of the pair of recesses is about 0.1 to 0.2 mm greater than the diameter of the shaft portion of the male member.

10. A connector for an automotive cable assembly comprising:
a female member having an opening extending transversely through the side thereof; and
a male member configured to seat in the side opening of the female member, wherein the male member is configured to load transversely into the side opening of the female member to securely couple the male and female members in axial alignment.

11. The connector of claim 10, wherein the side opening of the female member is dimensioned to accept the male member such that the male member is lockingly retained within the female member and is rotatable relative to the female member.

12. The connector of claim 10, wherein the female member comprises a body portion and a shaft portion coupled to the body portion, with the body portion including two legs and the side opening extending longitudinally between the two legs; and
the male member includes a head portion coupled to a shaft portion, said head portion having a greater transverse dimension than the shaft portion, with the head portion and shaft portion being positioned in the opening and the shaft portion extending axially from the opening.

13. The connector of claim 12, wherein the opening in the body portion includes an open channel that extends along at least part of the length of the body portion, and an open groove that is in communication with the open channel, said open groove having a greater transverse dimension than the open channel, with the head portion of the male member being positioned in the open groove and the shaft portion of the male member being positioned in and through the open channel.

14. The connector of claim 13, wherein the open channel includes a portion of larger dimension for receiving the shaft portion of the male member, with the male member being rotatably locked in the female member when the shaft portion is positioned in the portion of larger dimension.

15. A cable connector comprising:
a female member having a first cable connecting end and a second open end, the second open end comprising a body portion having a longitudinal channel that extends at least partially along the length of the body portion; and
a male member configured to securedly seat inside the second open end and the longitudinal channel of the female member, the male member comprising a head portion at a first end and a shaft portion at a second end, with the second end being a cable connecting end,
wherein the longitudinal channel includes a groove sized to receive the head portion of the male member, the longitudinal channel is configured to lockingly catch the shaft portion of the male member, and the male member is seated in the female member.

16. The cable connector of claim 15, wherein the longitudinal channel further comprises at least one recess for receiving the shaft of the male member.

17. The cable connector of claim 16, wherein the at least one recess comprises a pair of longitudinally extending recesses positioned inside and on opposite sides of the longitudinal channel between the groove and the second open end of the body portion of the female member, with the shaft portion of the male member being sized to be rotatably received between the recesses such that the male member locks in the female member.

18. The cable connector of claim 16, wherein the male member is axially aligned with the female member and the male member is rotatable relative to the female member.

19. A two part connector for an automotive cable assembly consisting essentially of:
a first part; and
a second part configured to couple to and coupled to the first part, wherein when the second part is coupled to the first part, the first and second parts are locked together.

20. The connector of claim 19, wherein the second part is configured to snap into an opening defined in the first part.

21. The connector of claim 19, wherein the first and second parts are coupled in axial alignment.

22. The connector of claim 19, wherein the first part is a female member that includes a longitudinally extending opening that is open from a side of and at least one end of the female member, and the second part is a male member configured to seat in the longitudinally extending opening of the female member.

23. The connector of claim 22, wherein the male member includes an enlarged head portion and a shaft portion, and the female member longitudinally extending opening is configured to accept the head and shaft portions of the male member such that the male member is locked in and rotatable relative to the female member.

24. A method of coupling an automotive cable assembly comprising:
providing a male member and a female member according to claim 1;
positioning the head portion of the male member into the open groove of the female member and positioning the shaft of the head portion into the open channel of the female member such that the male member is in axial alignment with and locked to the female member.

25. A method of coupling an automotive cable assembly comprising:
providing the male and female members according to claim 10;
transversely inserting the male member into the side opening of the female member such that the male member rotatably locks to the female member.

26. A method of coupling an automotive cable assembly comprising:
providing the first and second parts of claim 19;
inserting the second part into the first part until the first and second parts lock together.
